(19) United States
(12) Patent Application Publication
(10) Pub. No.: US 2021/0299615 A1
(43) Pub. Date: Sep. 30, 2021

(54) High-Flux Filter Membrane with Three-Dimensional and Self-Aligned Micropores Arrays and Method for Manufacturing Same

(71) Applicant: Guangzhou Anfang Biotechnology Co., Ltd., Guangzhou (CN)

(72) Inventors: Jian Shi, Guangzhou (CN); Yong Chen, Guangzhou (CN); Rui Liu, Guangzhou (CN); Li Wang, Guangzhou (CN)

(73) Assignee: Guangzhou Anfang Biotechnology Co., Ltd., Guangzhou (CN)

(21) Appl. No.: 17/262,657

(22) PCT Filed: Aug. 31, 2018
(86) PCT No.: PCT/CN2018/103388

§ 371 Date: Jan. 22, 2021

(30) Foreign Application Priority Data
Jul. 24, 2018 (CN) 201810820410.9

(51) Int. Cl. B01D 69/02; B01D 67/00; B01D 69/12; B01D 71/44

(52) U.S. Cl. CPC B01D 69/02; B01D 67/0034; B01D 69/12; B01D 2325/24; B01D 2325/021; B01D 2325/04; B01D 71/44

(57) ABSTRACT

The present invention discloses a high-flux filter membrane with three-dimensional self-aligned micropores arrays and a method for manufacturing the same. The filter membrane has an operating area and a filter area. The operating area is located around the filter membrane. The filter area is located in the middle of the filter membrane. The filter area is relatively concave to the operating area. Three-dimensional and self-aligned micropores are provided on the filter area and are upper pores and lower pores, which are coaxial pores. The upper pores connect with the lower pores. In the present invention, in one aspect, a fluid flux is increased by reducing the thickness of upper pores and increasing the pore diameter of the lower pores, and, in another aspect, mechanical strength of the filter membrane is increased by use of the lower pores.

### FIELD OF THE INVENTION

The present invention belongs to the field of micro-nano molding technologies for membrane devices, and relates to a filter membrane material, particularly to a high-flux filter membrane with three-dimensional and self-aligned micropores arrays and method for manufacturing same.

### BACKGROUND OF THE INVENTION

It is well known that a filter membrane is used to separate and filter out solid particles that exist in liquid or gas, through holding back the solid particles in the liquid or gas by filter pores to separate the solid particles from the liquid or gas. In the field of membrane separation technologies, microporous filter membranes are most widely applied in the field of scientific research, food inspection, chemical industry, nanotechnology, energy source, and environmental protection due to the characteristics with high porosity, zero medium shedding, thin texture, small resistance, fast filtration speed, slight adsorption and so on.

Most microporous filter membranes comprise regularly distributed cylindrical filter pores. The pore diameter ranges from 0.1 micrometer to 10 micrometers, and the thickness of membrane ranges from several micrometers to hundreds of micrometers. In practical application, filter membranes with different pore diameter are selected according to size of solid particles contained in the fluid for the purpose of holding back, separating, and filtering out the solid particles. Specifically, it is the fact that the size of solid particles larger than the pore diameter of the filter pores tends to be blocked by the filter pores and concentrate on the surface of a filter membrane, while the size of solid particles smaller than the pore diameter of the filter membrane tends to pass through the filter pores. Therefore, it requires selection of suitable pore diameter according to different standard of screening and separation to ensure a high holding back rate. It is known that during the process of filtration, the smaller pores will lead to the higher filtration resistance, lower filtration efficiency and easier blockage of the pores, which undoubtedly increases the requirement to new type of filter membrane.

To resolve these problems, filter membrane with precise pore diameter and shape is developed by use of the precise microfabrication technology to enhance the screening capability of the filter membrane. In addition, attempts have been made to increase the flux by increasing the porosity. However, the increase of porosity often leads that each two or more filter pores overlapping and communicating with others, which turns out to reduce the screening capability of the filter membrane. Besides, most microporous filter membranes only have cylindrical pores with vertically consistent in pore diameter, which are not suitable for screening of noncircular particles and deformable particles. Furthermore, during the process of filtering particles with relatively high density, some particles tend to be blocked in the filter pores. In particular, in the field of biomedical application, attempts have been made to separate cells from blood through the filter membrane in recent years. Blood cells blockage often lead to adverse effect on subsequent assay and analysis, and also reduce the signal-to-noise ratio. In addition, the increase number of blocked pores can increase the pressure difference of the filter membrane, which will have huge effect on the activity of the cells. Therefore, it is an objective to invent a filter membrane which enables to reduce the pressure difference of the membrane while ensuring the high flux and holding back rate in the field of filter membrane.

### SUMMARY OF THE INVENTION

To solve problems such as low screening capability, easy to be blocked, undesired flux and holding back rate, and large membrane pressure difference of existing microporous filter membrane, the present invention provides a high-flux filter membrane with three-dimensional and self-aligned micropores arrays and method for manufacturing same.

The objective of the present invention is realized by use of the following technical solution:

A high-flux filter membrane with three-dimensional and self-aligned micropores arrays, comprises: an operating area, wherein the operating area is located around the filter membrane; a filter area, wherein the filter area is located in the middle of the filter membrane and relatively concave to the operating area; and three-dimensional and self-aligned micropores, wherein three-dimensional and self-aligned micropores are provided on the filter area and comprise upper pores and lower pores, which are coaxial pores, the upper pores are cylindrical with pore diameter less than that of the lower pores, the upper pores connect with the lower pores, the fluid sequentially flows through the upper pores and the lower pores, and the lower pores are cylindrical pores or conical pores whose pore diameter gradually increases from top to bottom.

Preferably, in the high-flux filter membrane with three-dimensional and self-aligned micropores arrays, the filter area comprises: an upper membrane, wherein the thickness of the upper membrane ranges from 0.1 μm to 10 μm; a lower membrane, wherein the thickness of the lower membrane ranges from 1 μm to 50 μm, and the upper membrane and the lower membrane are assembled; upper pores, wherein the upper pores are penetrated pores provided on the upper membrane; and lower pores, wherein the lower pores are penetrated pores provided on the lower membrane.

Preferably, in the high-flux filter membrane with three-dimensional and self-aligned micropores arrays, the filter membrane is circular, with a diameter ranging from 1 mm to 100 mm, and the filter membrane is made of a transparent and photosensitive polymer or a transparent and thermosetting polymer.

Preferably, in the high-flux filter membrane with three-dimensional and self-aligned micropores arrays, the three-dimensional and self-aligned micropores are uniformly distributed in the filter area in arrays with a porosity ranging from 1% to 90%.

Preferably, in the high-flux filter membrane with three-dimensional and self-aligned micropores arrays, the diameter of the upper pores ranges from 1 μm to 10 μm, and the upper pores are periodically distributed in the range of 1.2 μm to 50 μm.

Preferably, in the high-flux filter membrane with three-dimensional and self-aligned micropores arrays, the lower pores are cylindrical pores with diameter ranging from 1.1 μm to 50 μm.

Preferably, in the high-flux filter membrane with three-dimensional and self-aligned micropores arrays, the lower pores are bowl-shaped pores, the top surface diameter of the lower pores ranges from 1.1 μm to 10 μm, and the bottom surface diameter of the lower pores ranges from 1.1 μm to 50 μm.

A method for manufacturing a high-flux filter membrane with three-dimensional and self-aligned micropores arrays, comprises: coating a metal layer on an optical template; forming a microporous structure on the metal layer; spin-coating a photoresist on the metal layer, back-side exposing and developing; depositing a polymer on the photoresist after development; spin-coating the photoresist on the polymer again, shifting by a certain angle, rotating, back-side overexposing, normally developing, and replicating using a soft photolithography method to obtain a silicone mold; and imprinting the silicone mold using an lithography technology to obtain the microporous filter membrane.

Preferably, the method for manufacturing a high-flux filter membrane with three-dimensional and self-aligned micropores arrays, comprises spin-coating the photoresist on the polymer, shifting by 5° to 30°, rotating, back-side overexposing, and normally developing to obtain a microporous filter membrane with bowl-shaped pores.

Preferably, in the method for manufacturing a high-flux filter membrane with three-dimensional and self-aligned micropores arrays, the polymer is parylene with a deposition thickness ranging from 10 nm to 500 nm.

Compared with the prior art, the present invention has the following beneficial effects: in one aspect, to increase the fluid flux by reducing the thickness of the upper pores and increasing the pore diameter of the lower pores, and in another aspect, to increase mechanical strength of a filter membrane by use of the lower pores. The method for manufacturing a filter membrane in the present invention is in combination of the photolithography, soft-lithography, the imprint technology, and the membrane transfer technology, which is simple, fast and suitable for the manufacture of microporous filter membranes with different materials and the applications in different fields.

### BRIEF DESCRIPTION OF THE DRAWINGS

To more clearly describe the technical solutions of the embodiments in the present invention or in the prior art, the brief introduction of the drawings required in the embodiments in the present invention or in the prior art is as following. Apparently, the drawings in the following description only refer to the embodiments described in the present invention, and other drawings may also be obtained according to these drawings without creative work by those skilled in the art.

FIG. 1 is a schematic view of the front structure of a high-flux filter membrane with three-dimensional and self-aligned micropores arrays in Embodiment 1;

FIG. 2 is a schematic view of the reverse structure of a high-flux filter membrane with three-dimensional and self-aligned micropores arrays in Embodiment 1;

FIG. 3 is a sectional view of a high-flux filter membrane with three-dimensional and self-aligned micropores arrays in Embodiment 1;

FIG. 4 is an enlarged view of a high-flux filter membrane with three-dimensional and self-aligned micropores arrays in Embodiment 1;

FIG. 5 is a schematic view of the front structure of a high-flux filter membrane with three-dimensional and self-aligned micropores arrays in Embodiment 2;

FIG. 6 is a schematic view of the reverse structure of a high-flux filter membrane with three-dimensional and self-aligned micropores arrays in Embodiment 2;

FIG. 7 is a sectional view of a high-flux filter membrane with three-dimensional and self-aligned micropores arrays in Embodiment 2;

FIG. 8 is an enlarged view of a high-flux filter membrane with three-dimensional and self-aligned micropores arrays in Embodiment 2;

FIG. 9 is a flowchart of a method for manufacturing a high-flux filter membrane with three-dimensional and self-aligned micropores arrays in Embodiment 3;

FIG. 10 is an scanning electronic microscope image of a male membrane of the method for manufacturing a high-flux filter membrane with three-dimensional and self-aligned micropores arrays in Embodiment 3;

FIG. 11 is an scanning electron microscope image of a filter membrane of the method for manufacturing a high-flux filter membrane with three-dimensional and self-aligned micropores arrays in Embodiment 3; and

FIG. 12 is a sectional view of a filter membrane of the method for manufacturing a high-flux filter membrane with three-dimensional and self-aligned micropores arrays in Embodiment 3,

In the Figures: 1. Operating area; 2. Filter area, 21. Upper membrane; 22. Lower membrane; 3. Three-dimensional and self-aligned micropore; 4. Upper pore; and 5. Lower pore.

### DETAILED DESCRIPTION OF THE EMBODIMENTS

For better understanding of the present invention, the present invention is further described below in detail with reference to the following embodiments which should not be considered as the limitations to the present invention. Any unessential modifications and variations made by the person skilled in the art according to the foregoing descriptions shall all fall within the scope of the appended claims.

### Embodiment 1

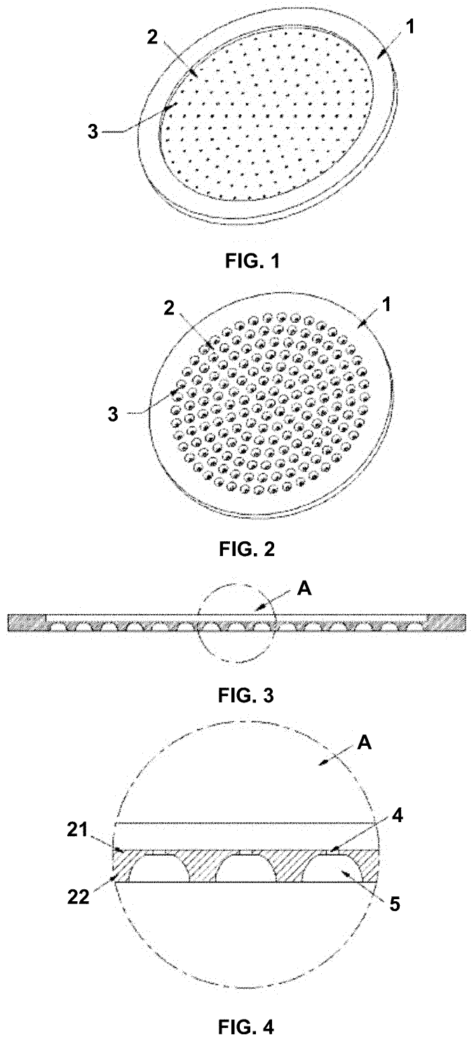

As shown in FIG. 1 to FIG. 4, a high-flux filter membrane with three-dimensional and self-aligned micropores arrays, comprises: an operating area 1, wherein the operating area 1 is located around the filter membrane; a filter area 2, wherein the filter area 2 is located in the middle of the filter membrane and relatively concave to the operating area 1; and three-dimensional and self-aligned micropores 3; wherein three-dimensional and self-aligned micropores 3 are provided on the filter area 2 and comprise upper pores 4 and lower pores 5; the upper pores 4 and the lower pores 5 are coaxial pores; the upper pores 4 are cylindrical poreswith diameter is less than that of the lower pores 5; the upper pores 4 connect with the lower pores 5; the fluid sequentially flows through the upper pores 4 and the lower pores 5; the lower pores 5 are conical pores whose pore diameter gradually increases from top to bottom.

The filter membrane is circular with diameter ranges from 1 mm to 100 mm, and the filter membrane is made of a transparent and photosensitive polymer (e.g. PEGDA, ORMOCLEAR, NOA, and the like) or a transparent and thermosetting polymer (e.g. EPDXY, PDMS, and the like).

The filter area 2 comprises: an upper membrane 21, wherein the thickness of the upper membrane 21 ranges from 0.1 μm to 10 μm; a lower membrane 22, wherein the thickness of the lower membrane 22 ranges from 1 μm to 50 μm, and the upper membrane 21 and the lower membrane 22 are assembled; upper pores 4, wherein the upper pores 4 are penetrated pores provided on the upper membrane 21; and lower pores 5, wherein the lower pores 5 are penetrated pores provided on the lower membrane 22.

The three-dimensional and self-aligned micropores 3 are uniformly distributed in the filter area 2 in arrays with a porosity ranging from 1% to 90%. The diameter of the upper pores 4 ranges from 1 μm to 10 μm. The upper pores 4 are periodically distributed in the range of 1.2 μm to 50 μm. The lower pores 5 are bowl-shaped pores, a top surface diameter of the lower pores 5 ranges from 1.1 μm to 10 μm, and a bottom surface diameter of the lower pores 5 ranges from 1.2 μm to 50 μm.

### Embodiment 2

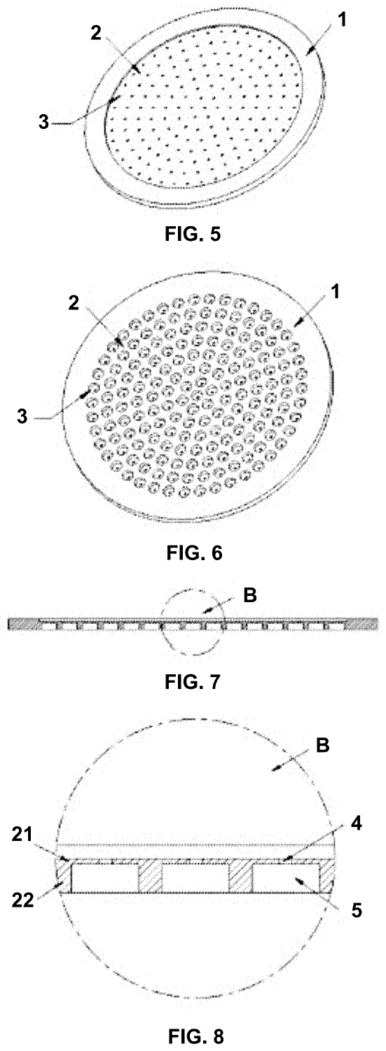

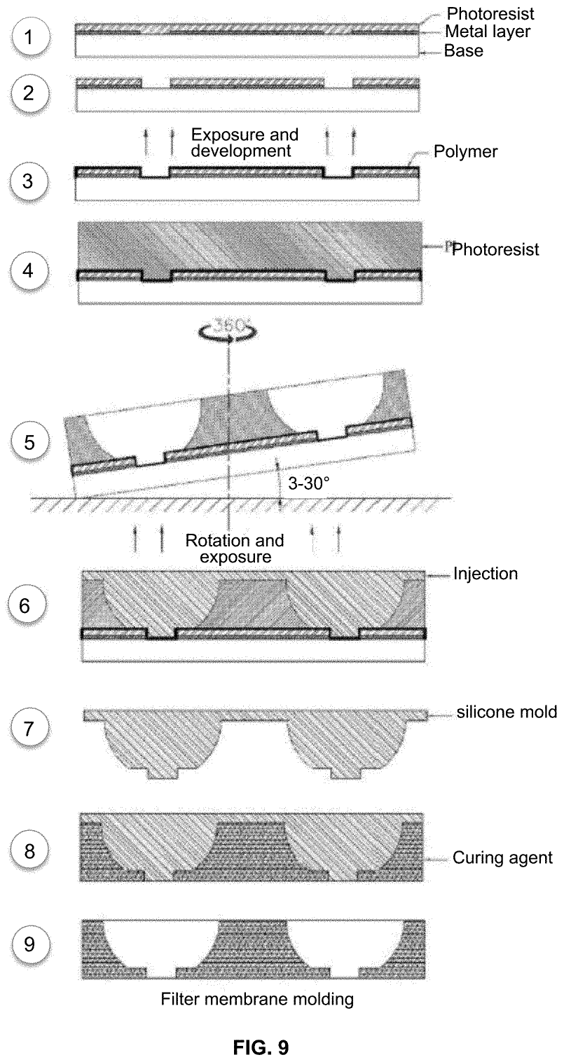

As shown in FIG. 5 to FIG. 8, based on Embodiment 1, the lower pores 5 are cylindrical pores with diameter ranging from 1.1 μm to 50 μm.

### Embodiment 3

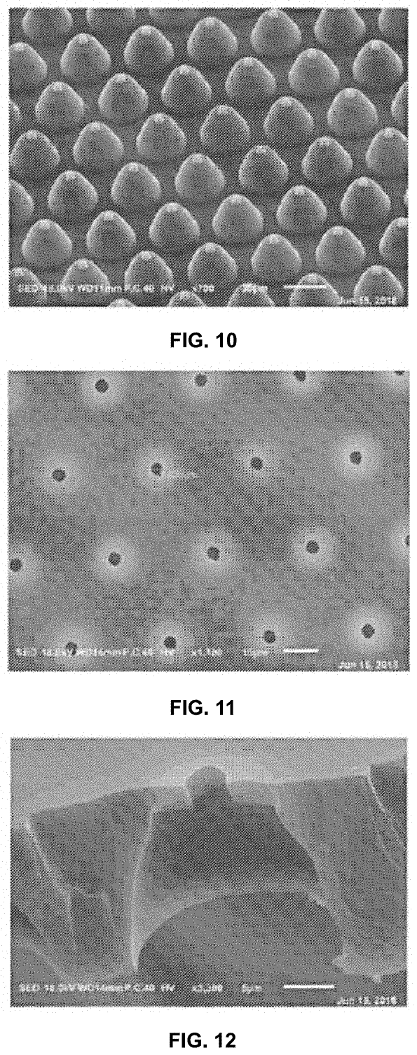

A method for manufacturing a high-flux filter membrane with three-dimensional and self-aligned micropores arrays, comprises: coating a metal layer (e.g. chromium, gold, and the like) on an optical template (base); forming a microporous structure on the metal layer; spin-coating a photoresist on the metal layer, back-side exposing and developing; depositing a polymer on the photoresist after development; spin-coating the photoresist on the polymer again, shifting upward by 30°, rotating, back-side overexposing, normally developing, and replicating using a soft photolithography method to obtain a silicone mold (as shown in FIG. 10); and imprinting the silicone mold using an lithography technology to obtain the microporous filter membrane.

The polymer is parylene with a deposition thickness ranging from 10 nm to 500 nm.

FIG. 11 is an scanning electronic microscope of the surface of the microporous filter membrane manufactured in the present application. As shown in FIG. 11, the filter pores are uniformly distributed on the surface of the filter membrane, and the diameter of the filter pores is 3.636 μm according to scale calculation. FIG. 12 is proposed for better description of the structure of the filter pores in the present application, which shows the sectional sample of the microporous filter membrane. FIG. 12 clearly shows the structure of the upper pores communicating with lower pores, and the upper pores are cylindrical pores and the lower pores are bowl-shaped pores. The pore diameter of the upper pores is approximately 4 μm, which is consistent with the pore diameter of the filter pore in FIG. 11. The bottom surface radius of the lower pores is approximately 20 μm.

The above embodiments are merely exemplary embodiments in the present invention and are not intended to limit the present invention. Any modification, equivalent replacement, and improvement made without departing from the spirit and principle of the present invention shall all fall within the scope of the appended claims.

1: A high-flux filter membrane with three-dimensional and self-aligned micropores arrays, comprising:
an operating area, wherein the operating area is located around the filter membrane,
a filter area, wherein the filter area is located in the middle of the filter membrane and relatively concave to the operating area, and
three-dimensional and self-aligned micropores, wherein the three-dimensional and self-aligned micropores are provided on the filter area and comprise upper pores and lower pores, which are coaxial pores, the upper pores are cylindrical pores with a pore diameter less than that of the lower pores, the upper pores connect with the lower pores, the fluid sequentially flows through the upper pores and the lower pores, and the lower pores are cylindrical pores or conical pores whose pore diameter gradually increases from top to bottom.

2: The high-flux filter membrane with three-dimensional and self-aligned micropores arrays according to claim 1, wherein the filter area comprises:
an upper membrane, wherein the thickness of the upper membrane ranges from 0.1 μm to 10 μm;
a lower membrane, wherein the thickness of the lower membrane ranges from 1 μm to 50 μm, and the upper membrane and the lower membrane are assembled;
upper pores, wherein the upper pores are penetrated pores provided on the upper membrane; and
lower pores, wherein the lower pores are penetrated pores provided on the lower membrane.

3: The high-flux filter membrane with three-dimensional and self-aligned micropores arrays according to claim 1, wherein the filter membrane is circular with a diameter ranging from 1 mm to 100 mm, and the filter membrane is made of a transparent and photosensitive polymer or a transparent and thermosetting polymer.

4: The high-flux filter membrane with three-dimensional and self-aligned micropores arrays according to claim 1, wherein the three-dimensional and self-aligned micropores are uniformly distributed in the filter area in arrays with a porosity ranging from 1% to 90%.

5: The high-flux filter membrane with three-dimensional and self-aligned micropores arrays according to claim 1, wherein the diameter of the upper pores ranges from 1 μm to 10 μm, and the upper pores are periodically distributed from 1.2 μm to 50 μm.

6: The high-flux filter membrane with three-dimensional and self-aligned micropores arrays according to claim 1, wherein the lower pores are cylindrical pore with diameter in the range of 1.1 μm to 50 μm.

7: The high-flux filter membrane with three-dimensional and self-aligned micropores arrays according to claim 1, wherein a lower pores are bowl-shaped pores, the top surface diameter of the lower pores ranges from 1.1 μm to 10 μm, and a bottom surface diameter of the lower pores ranges from 1.1 μm to 50 μm.

8: A method for manufacturing a high-flux filter membrane with three-dimensional and self-aligned micropores arrays, comprising:
coating a metal layer on an optical template;
forming a microporous structure on the metal layer;
spin-coating a photoresist on the metal layer, back-side exposing and developing;
depositing a polymer on the photoresist after development;
spin-coating the photoresist on the polymer again, shifting by a certain angle, rotating, back-side overexposing normally developing, and replicating using a soft photolithography method to obtain a silicone mold, and
imprinting the silicone mold using an lithography technology to obtain the microporous filter membrane.

9: The method for manufacturing a high-flux filter membrane with three-dimensional and self-aligned micropores arrays according to claim 8, comprising spin-coating the photoresist on the polymer, shifting by 5° to 30°, rotating, back-side overexposing, and normally developing to obtain a microporous filter membrane with bowl-shaped pores.

10: The method for manufacturing a high-flux filter membrane with three-dimensional and self-aligned micropores arrays according to claim 8, wherein the polymer is parylene with a deposition thickness ranging from 10 nm to 500 nm.
